(19) United States
(12) Patent Application Publication
(10) Pub. No.: US 2018/0073498 A1
(43) Pub. Date: Mar. 15, 2018

(54) Method For Regulating A Fuel Delivery Pump

(71) Applicant: CONTINENTAL AUTOMOTIVE GmbH, Hannover (DE)

(72) Inventor: Gerald BEHRENDT, Frankfurt am Main (DE)

(21) Appl. No.: 15/567,895

(22) PCT Filed: Apr. 25, 2016
(86) PCT No.: PCT/EP2016/059163

§ 371 Date: Oct. 19, 2017

(30) Foreign Application Priority Data
Apr. 27, 2015 (DE) 10 2015 207 682.2

(51) Int. Cl. F04B 49/08; F02D 41/30; F04B 17/03; F04B 49/06; F04B 49/20

(52) U.S. Cl. CPC F04B 49/08; F02D 41/3082; F02D 2041/1409; F04B 49/065; F04B 49/20; F04B 17/03

(57) ABSTRACT

A method for regulating a fuel delivery system, having a fuel delivery pump and an electric motor. The fuel delivery pump is driven by the electric motor, which is actuated by an actuation current. At a predefinable time the actual volume (delivered by the fuel delivery pump is determined at an actual pressure that prevails at this time. A target rotational speed for the electric motor driving the fuel delivery pump is derived from the determined actual volume and a target pressure.

### CROSS REFERENCE TO RELATED APPLICATIONS

This is a U.S. national stage of application No. PCT/EP2016/059163, filed on Apr. 25, 2016. Priority is claimed on German Application No. DE102015207682.2, filed Apr. 27, 2015, the content of which is incorporated here by reference.

### BACKGROUND OF THE INVENTION

### 1. Field of the Invention

The invention relates to a method for controlling a fuel delivery system, having a fuel delivery pump and an electric motor, wherein the fuel delivery pump can be driven by the electric motor and the electric motor can be actuated by an actuation current.

### 2. Description of the Prior Art

Motor vehicles driven by an internal combustion engine have a fuel delivery system configured to deliver fuel from the tank to the internal combustion engine. The fuel delivery system usually has a fuel delivery pump that has at least one pumping mechanism and an electric motor. The rotational speed of the electric motor can be influenced by adapting the current strength at the electric motor, and, in this way, the delivery capacity of the fuel delivery system can be influenced.

Devices that are regulated on the basis of the pressure prevailing in the fuel delivery system are known in the prior art. In this context, a target rotational speed necessary for the desired delivery quantity to be delivered by the fuel delivery pump is determined on the basis of a known target pressure and a known actual pressure by a simple regulator, for example a PID controller. The electric motor is actuated here by the PID controller such that the target rotational speed is set, the target rotational speed having been acquired as a function of the desired target pressure.

A disadvantage with these devices is that the regulation quality of a simple regulator is not equally good over the entire working range of the regulator. In many ranges, in particular in low rotational speed ranges, this leads to severe overshooting and in some cases to resonances. At the same time, in particularly high rotational speed ranges a significantly slower regulating speed often has to be expected, or it has to be expected that the regulator can only react insufficiently with interfering influences.

### SUMMARY OF THE INVENTION

One object of the present invention is to provide a method that permits regulation of the fuel delivery system which is improved with respect to the regulation speed and the regulation quality.

One aspect of the invention relates to a method for regulating a fuel delivery system, having a fuel delivery pump and an electric motor, wherein the fuel delivery pump can be driven by the electric motor and the electric motor can be actuated by an actuation current, wherein at a predefinable time the actual volume delivered by the fuel delivery pump is determined at an actual pressure prevails at this time, and a target rotational speed for the electric motor driving the fuel delivery pump is derived from the determined actual volume and a target pressure.

This is particularly advantageous since not only is a target rotational speed derived on the basis of an actual pressure and a target pressure, but also the delivered volume is used as an intermediate variable. The delivered actual volume is preferably determined on the basis of the actual pressure and the actual rotational speed, as a result of which a statement can be achieved by the actual volume with a high accuracy. The actual volume is then preferably re-used in a further acquisition process in which a target rotational speed can be acquired using the target pressure, which can also be predetermined with a high quality, and said target rotational speed is fed to the electric motor as a target predefinition.

Overall, the determination of the target rotational speed is very accurate and is subject to only small interfering influences.

The electric motor is preferably controlled by the variation of the current with which it is actuated. The necessary current strength for achieving a certain target rotational speed and under given boundary conditions can be predefined very accurately on the basis of the known characteristic of the electric motor and of the rest of the fuel delivery system. In particular, the pressure prevailing in the fuel delivery system is a relevant boundary condition here.

It is particularly advantageous if the actual volume delivered by the fuel delivery pump at the predefineable time is acquired from a known characteristic diagram with knowledge of the prevailing actual pressure and of the present actual rotational speed.

For each specific fuel delivery system, it is possible to acquire a characteristic diagram that forms a relationship between the delivered volume, the rotational speed and the pressure prevailing in the fuel delivery system. A typical characteristic diagram shows the rotational speed of the fuel delivery pump on the X axis, and the delivered volume and curves which run as isobars in a quadrant extending through the axes on the Y axis. In this way, the third missing value can be acquired with two known values in each case.

It is to be particularly preferred here if the respectively known values have been acquired at the same time, since all the values can change in the course of time, wherein large changes can occur in very short time periods. It is advantageous here if the value determination takes place at a predefined time. Of course, the acquisition process can also take place in an uninterruptedly continuous fashion. In this context, it is, however, advantageous if the actual values that are acquired in each case from the fuel delivery system are always acquired at an identical time.

It is also advantageous if the actual volume is determined from a known characteristic diagram with knowledge of the actual pressure and the actual actuation current.

In an alternative characteristic diagram, the actuation current is plotted instead of the rotational speed. The characteristic diagram retains its superordinate information and will only appear changed. The pressure can also be inferred from the strength of the actuation current and the respectively delivered volume, and vice versa. An alternative way of acquiring the delivered actual volume is therefore provided.

One preferred exemplary embodiment is characterized in that the target rotational speed for the electric motor is acquired from a characteristic diagram by the acquired actual volume and the predefinable target pressure.

This is particularly advantageous since the value of the target rotational speed can also be determined particularly easily from a characteristic diagram. A characteristic diagram is advantageously used which has the rotational speed on the X axis, the delivered volume on the Y axis, and curves in the form of isobars in the quadrant spanned by the axes, wherein the isobars correspond to the pressure respectively prevailing in the fuel delivery system. The target pressure and the delivered actual volume determined as an intermediate variable are used as known variables in order to acquire a target rotational speed. This is particularly easily possible and can therefore be brought about quickly.

The required characteristic diagrams can be produced on the basis of calculated values and/or on the basis of empirically acquired values. Since there is a direct physical relationship between the pressure and the delivery quantity, a good correlation can be achieved here.

It is also to be preferred if the actual volume and the target rotational speed are acquired from the same characteristic diagram.

Both the actual volume, which is used as an intermediate variable for determining the target rotational speed, and the target rotational speed are particularly preferably acquired on the basis of the same characteristic diagram. This is advantageous since only one characteristic diagram has to be represented in the vehicle electronics.

This saves storage capacity and leads overall to a more favorable configuration of the fuel delivery system. Moreover, fault sources are reduced, as a result of which the quality of the regulation method is improved overall.

In alternative configurations the characteristic diagram can also be present in a tabular form or in the form of calculation rules. Further influences can also be taken into account in the characteristic diagram with the result that a further increase in the accuracy can be achieved.

Moreover, it is advantageous if the acquired actual volume is processed in a correction module, wherein in addition the actual pressure and the target pressure are input into the correction module and an adapted actual volume is acquired, wherein a target rotational speed for the electric motor is acquired from the adapted actual volume and the target pressure by a known characteristic diagram.

A correction module can be embodied as a separate component or can be stored as a computing routine in one of the control units. The correction module preferably serves to correct the value acquired in the fuel delivery system for the delivered actual volume. In this context, in particular interfering influences from outside or from inside the fuel delivery system are to be minimized or entirely eliminated.

The acquisition of the target rotational speed can also take place in the correction module. As an alternative to this, a separate module can also be provided. The correction module is mainly intended to counteract the influence of the change in volume over pressure to exclude this fault source. However, other interfering influences can also be removed from the calculation of the target value for the target rotational speed by the correction module by corresponding algorithms and computing methods.

Furthermore, it is advantageous if the correction module is used to correct the pressure-dependent change in the delivered volume. This is advantageous since the pressure-dependent change in volume cannot be influenced and therefore this phenomenon will always occur.

It is always expedient if the correction module for correcting the actual volume also receives input variables that represent the pressure-dependent behavior of further elements of the fuel delivery system. These include, in particular, a suction jet pump and/or a venturi pump and/or a nozzle.

Since the fuel delivery system also has, in addition to the main fuel delivery pump, secondary pumps, which are necessary, for example, for the filtering or the drawing in of the fuel, a change in pressure also acts, in particular, on these secondary pumps. Therefore, it is advantageous overall to take into account this pressure-dependent behavior in order to keep the quality of the acquired value for the target rotational speed as high as possible.

Moreover, it is advantageous if the acquired target rotational speed for the electric motor is fed as an input variable into a PID controller, and the electric motor is actuated by the PID controller.

A PID controller can advantageously carry out rapid regulation with a high regulation quality. The target rotational speed acquired with high accuracy can therefore easily be obtained satisfactorily and reliably in that the regulator selects, as a function of the respective target rotational speed, a suitable current strength for actuating the electric motor.

Furthermore, it is advantageous if the actual pressure is acquired by a pressure sensor or by virtue of the fact that the actual pressure is acquired by a calculation method and/or a comparison method.

Depending on the design of the fuel delivery system, the acquisition of the pressure prevailing in the fuel delivery system can advantageously take place with a dedicated pressure sensor or without a pressure sensor using calculation methods and/or comparison methods.

### BRIEF DESCRIPTION OF THE DRAWINGS

Advantageous developments of the present invention are described in the dependent claims and in the following description of the figures.

In the text which follows, the invention will be explained in detail on the basis of an exemplary embodiments and with reference to the drawings, in which:

FIG. 1 is a block diagram in which the sequence of the method depicted;

FIG. 2 is a characteristic diagram for the delivered volume plotted against the rotational speed, wherein isobars are drawn in the coordinate system;

FIG. 3 is a block circuit diagram of the method; and

FIG. 4 is a block diagram of the method.

### DETAILED DESCRIPTION OF THE PRESENTLY PREFERRED EMBODIMENTS

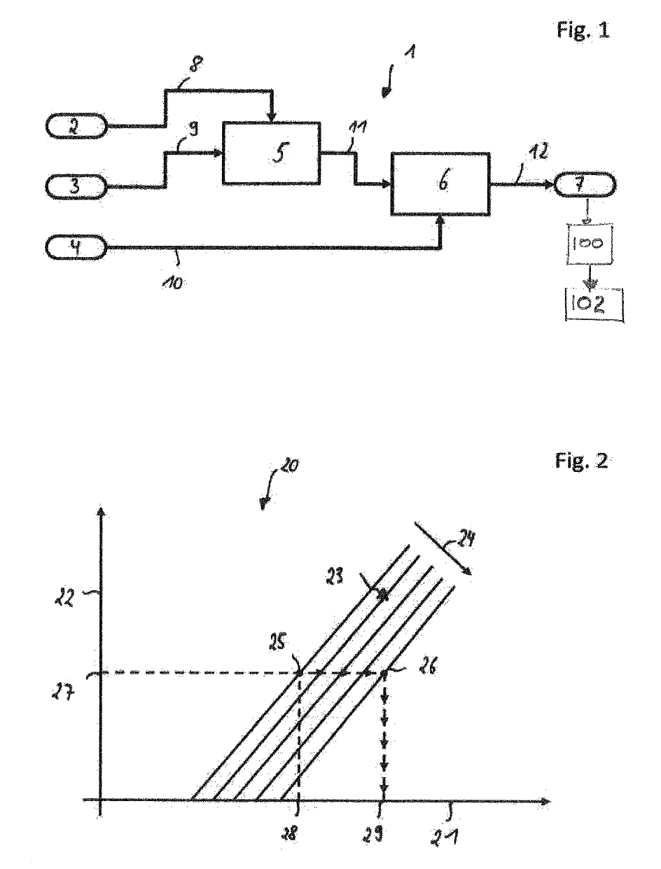

FIG. 1 shows a block circuit diagram 1, which represents the sequence of the method according to the invention. In each case input variables are input into the method via the blocks 2, 3, and 4 and are processed in blocks 5 and 6. Finally, a generated output variable is output via the block 7.

The block 2 illustrates as an input variable the current actual pressure at the time of the acquisition of data. The actual pressure can be determined both in a classic fashion by a pressure sensor and can be determined by a calculation method or by comparison methods. The current actual rotational speed, which corresponds to the rotational speed present at the electric motor or the pumping mechanism at the time at which the actual pressure was also acquired, is input as a further input variable via the block 3.

The input variables are fed to the block 5 via the signal lines 8 and 9. In the block 5, an actual volume delivered by the fuel delivery system at a given actual rotational speed and given actual pressure is determined from the actual pressure and the actual rotational speed using known characteristic diagrams which represent the respective fuel delivery system. The actual volume is passed on to the block 6 via the signal line 11.

Moreover, the input variable of the target pressure, which originates from the block 4 and describes the aimed-at target pressure, is fed into the block 6 via the signal line 10. In the block 6, a target rotational speed, which is finally output via the block 7 as an output variable via the signal line 12 is acquired using the actual volume from block 5 and the target pressure. The acquisition of the target rotational speed can also be carried out by a characteristic diagram with knowledge of the actual volume and the target pressure. In an ideal case, it is even possible to use in block 6 the same characteristic diagram, which has already also been used in block 5.

The actual volume is generated as an intermediate variable in the method according to FIG. 1, wherein the actual volume is acquired on the basis of values which have high accuracy. The use of the actual volume is particularly advantageous since the physical behavior of the pump is taken into account directly. An additional volume adaptation, as shown in the exemplary embodiment in FIG. 4, can also bring about adaptation to the respectively used control system and, in particular, to the physical properties thereof.

FIG. 2 shows a diagram 20 that illustrates, in particular, a characteristic diagram such as has been used for the acquisition of the actual volume in block 5 of FIG. 1 and the acquisition of the target rotational speed in block 6 of FIG. 1. The diagram 20 is exemplary and represents a possible configuration of a fuel delivery system.

The X axis on which the revolutions of the electric motor are plotted per minute is denoted by the reference symbol 21. This can also be the rotational speed of the pumping mechanism of the fuel delivery pump. In a normal case, these rotational speeds are essentially identical, since the pumping mechanism is usually driven directly by the electric motor without a transmission ratio.

The Y axis on which the delivered volume is plotted in l/h is denoted by the reference symbol 22. In the square which is spanned by the axes 21, 22 a multiplicity of straight lines 23 are illustrated which form isobars. Along each of the straight lines 23 the same pressure therefore prevails in the fuel delivery system. The respective pressure of the isobars 23 increases along the arrow 24.

On the basis of an actual rotational speed which is represented, for example, by the point 28, given a known actual pressure 25 the working point, to which an actual volume corresponding to the point 27 is assigned, can be determined from the diagram 20. This actual volume 27 corresponds therefore to the variable generated as an output variable in block 5 of FIG. 1 and is transferred into the block 6 via the signaling line 11.

On the basis of the actual volume 27, by using the target pressure 26 from block 3 in FIG. 1, a working point, to which the associated target rotational speed 29 is assigned, is arrived at in FIG. 2. This method corresponds to block 6 in FIG. 2.

By using a characteristic diagram as is shown by the diagram 20 in FIG. 2, the actual volume can therefore be determined, and given a known target pressure the target rotational speeds can be determined for different operating states of a fuel delivery pump.

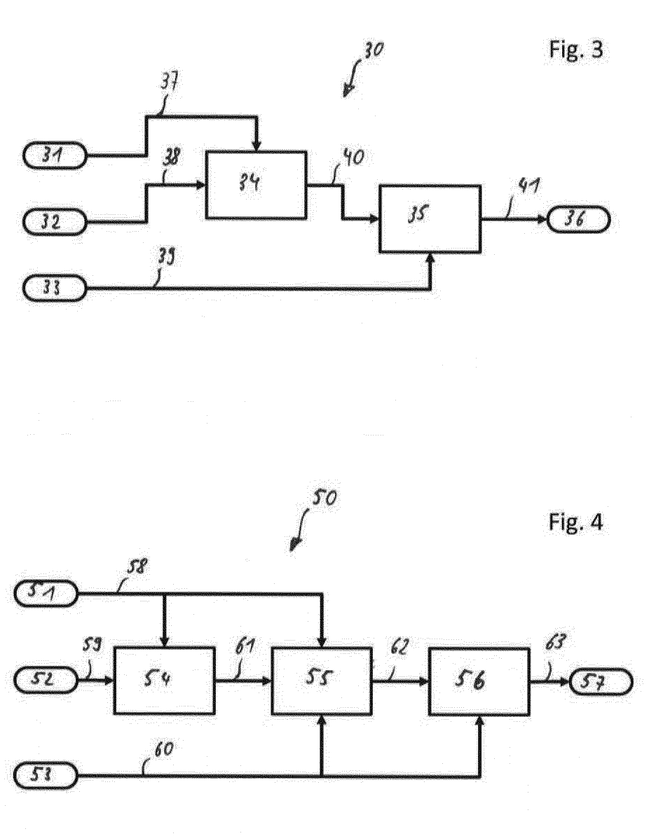

FIG. 3 shows a block circuit diagram 30, wherein the input variables are made available via the blocks 31, 32 and 33. The output variable is output by block 36. In block 34, the acquisition of the actual volume takes place, said actual volume being processed in block 35 to form a target rotational speed. The input variables are distributed between the blocks 34 and 35 via the signal lines 37, 38 and 39. The design of the block circuit diagram 30 is the same in many parts as that of the block circuit diagram 1 in FIG. 1. In contrast to FIG. 1, the actual rotational speed is not fed as an input variable via the block 32 but instead the actual current strength with which the electric motor is energized at the time under consideration is fed.

In a known fuel delivery system, the rotational speed of the electric motor can also be inferred from the current strength with which the electric motor is actuated. The current strength therefore forms a variable that can be replaced by the rotational speed. Both variables can be used synonymously in the method according to the invention.

As in FIG. 1, the acquired actual volume fed via a signal line 40 to the block 35 where a target rotational speed is acquired using the target pressure and is output as a basis for actuation of the electric motor.

FIG. 4 shows an alternative configuration of a block circuit diagram 50 which represents the method according to the invention in an extended form.

The input variables of the actual pressure, actual rotational speed and target pressure are fed in via the blocks 51, 52 and 53. In block 54, the actual pressure and the actual rotational speed, which are fed into the block 54 along the signal line 59, are processed to form an actual volume. The actual volume is then conducted via the signal line 61 into the block 55 where it is processed to form an adapted actual volume, including the actual pressure which is fed in via the signal line 58, and the target pressure which is fed in via the signal line 60.

By the adaptation in block 55, a fault correction of the acquired actual volume is to take place. Moreover, the influences of other interfering variables acting on the actual volume can also be eliminated in block 55. In particular, the property that the volume changes with the pressure can be compensated.

The adapted actual volume is then fed via the signal line 62 into the block 56 where a target rotational speed is acquired using the target pressure in a way analogous to the exemplary embodiments in FIGS. 1 and 3. This target rotational speed is output to the block 57 as an output variable via the signal line 63.

The output variables, which are output via the blocks 7, 36, and 57 can be fed directly into a control unit 100 that brings about the actuation of the electric motor 102. In particular, the output variables can also be fed into a classic PID controller which converts the target rotational speed into a respective actuation current and feeds it to the electric motor.

Combinations of exemplary embodiments in FIGS. 1, 3, and 4 can also be provided. In particular, the actual current can also be used as one of the input variables in FIG. 4, as it is used, for example, in FIG. 3.

The exemplary embodiments in FIGS. 1 to 4 have, in particular, no restrictive character and serve to clarify the inventive concept.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A method for regulating a fuel delivery system, having a fuel delivery pump and an electric motor, wherein the fuel delivery pump is driven by the electric motor and the electric motor is actuated by an actuation current, comprising:
determining, at a predefinable time, an actual volume delivered by the fuel delivery pump at an actual pressure that prevails at the predefinable time; and
deriving a target rotational speed for the electric motor driving the fuel delivery pump from the determined actual volume and a target pressure.

12. The method as claimed in claim 11, wherein the actual volume delivered by the fuel delivery pump at the predefinable time is acquired from a known characteristic diagram based on a prevailing actual pressure and a present actual rotational speed.

13. The method as claimed in claim 11, wherein the actual volume is acquired from a known characteristic diagram based on an actual pressure and an actual actuation current.

14. The method as claimed in claim 11, wherein a target rotational speed of the electric motor is acquired from a characteristic diagram based on the determined actual volume and the target pressure.

15. The method as claimed in claim 11, wherein the determined actual volume and the target rotational speed are acquired from a same characteristic diagram.

16. The method as claimed in claim 11, wherein the determined actual volume is processed in a correction module, wherein the actual pressure and the target pressure are input into the correction module and an adapted actual volume is acquired, wherein a target rotational speed for the electric motor is acquired from the adapted actual volume and the target pressure based on a known characteristic diagram.

17. The method as claimed in claim 16, wherein the correction module corrects a pressure-dependent change in the delivered volume.

18. The method as claimed in claim 16, wherein the correction module further receives input variables that represent a pressure-dependent behavior of at least one of a suction jet pump, a venturi pump, and a nozzle.

19. The method as claimed in claim 11, wherein the target rotational speed for the electric motor is fed as an input variable into a PID controller, and the electric motor is actuated by the PID controller.

20. The method as claimed in claim 11, wherein the actual pressure is acquired by one of a pressure sensor, a calculation method, and a comparison method.
